(19) United States
(12) Patent Application Publication
(10) Pub. No.: US 2024/0249291 A1
(43) Pub. Date: Jul. 25, 2024

(54) SHOPPING GUIDING WITH ROBOT ASSISTANCE

(71) Applicant: Nokia Technologies Oy, Espoo (FI)

(72) Inventor: Nan HU, Shanghai (CN)

(21) Appl. No.: 18/561,540

(22) PCT Filed: Jun. 1, 2021
(86) PCT No.: PCT/CN2021/097786

§ 371 Date: Nov. 16, 2023

(51) Int. Cl. G06Q 30/015; G05D 1/644; G05D 1/686; G05D 105/20; G05D 107/70; G05D 111/30; G06Q 10/0836; G06Q 30/0283; G06Q 30/0601; G06T 7/70; G06V 20/52; G06V 40/10

(52) U.S. Cl. CPC G06Q 30/015; G05D 1/644; G05D 1/686; G06Q 10/0836; G06Q 30/0283; G06Q 30/0633; G06T 7/70; G06V 20/53; G06V 40/10; G05D 2105/20; G05D 2107/70; G05D 2111/30; G06T 2207/30196; G06T 2207/30232; G06T 2207/30242

(57) ABSTRACT

A shopping guiding with robot assistance. A shopping list (115) of a customer (105) is obtained, wherein the shopping list (115) comprises a plurality of commodities to be picked up. Further, a first set of commodities (125) are determined from the plurality of commodities based on predicted picking up costs for the plurality of commodities, and at least one robot (130) are assigned for automatically picking up the first set of commodities (125). As such, at least one robot (130) may be assigned for picking up commodities with a relative high picking up cost, thereby increasing the efficiency for shopping and decreasing the safety risks.

### FIELD

Embodiments of the present disclosure generally relate to the field of computer technologies and in particular, to a method, device, apparatus and computer readable storage medium for shopping guiding with robot assistance.

### BACKGROUND

Shopping for example in a supermarket is always an indispensable part of people's daily life. For shopping in a large supermarket, a plurality of kinds of commodities will be placed on different shelves in different shopping areas, and people need to pick up the commodities by themselves. However, such commodities may be located in different shopping areas and different shelves. It may therefore take people a long time to pick up all the commodities, which may lead to a bad shopping experience.

In a weekend or a holiday, a large number of customers may gather in a same shopping area in the supermarket, which may result in an even longer time to pick up the commodity. Further, under a situation that diseases like COVID-19 widely spreads, the crowd congestion in a shopping area may lead to an increase of a possibility of virus transmission.

Therefore, it is desired to provide the customers a more efficient and safe way to pick up the commodities they want to buy.

### SUMMARY

In general, example embodiments of the present disclosure provide a solution for shopping guiding with robot assistance.

In a first aspect, there is provided a method. The method comprises obtaining a shopping list of a customer, the shopping list comprising a plurality of commodities to be picked up; determining, from the plurality of commodities, a first set of commodities based on predicted picking up costs for the plurality of commodities; and causing at least one robot for automatically picking up the first set of commodities.

In a second aspect, there is provided a device. The device comprises at least one processor; and at least one memory including computer program code; where the at least one memory and the computer program code are configured to, with the at least one processor, cause the device to obtain a shopping list of a customer, the shopping list comprising a plurality of commodities to be picked up; determine, from the plurality of commodities, a first set of commodities based on predicted picking up costs for the plurality of commodities; and cause at least one robot for automatically picking up the first set of commodities.

In a third aspect, there is provided an apparatus comprising means for obtaining a shopping list of a customer, the shopping list comprising a plurality of commodities to be picked up; determining, from the plurality of commodities, a first set of commodities based on predicted picking up costs for the plurality of commodities; and causing at least one robot for automatically picking up the first set of commodities.

In an fourth aspect, there is provided a non-transitory computer readable medium comprising program instructions for causing an apparatus to perform at least the method according to the first aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an environment in which example embodiments of the present disclosure can be implemented;

FIG. 2 illustrates a flowchart illustrating a process for shopping guiding according to some example embodiments of the present disclosure;

FIG. 3 illustrates a flowchart of a process for determining the first set of commodities according to some example embodiments of the present disclosure;

FIG. 4 illustrates a block diagram of an example shopping system according to some example embodiments of the present disclosure;

FIG. 5 illustrates a simplified block diagram of an apparatus that is suitable for implementing example embodiments of the present disclosure; and

FIG. 6 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry), and
(b) combinations of hardware circuits and software, such as (as applicable):
   (i) a combination of analog and/or digital hardware circuit(s) with software/firmware, and
   (ii) any portions of hardware processor(s) with software (including digital signal processor(s), software, and memory(ies) that work together to cause an apparatus, such as a mobile phone or server, to perform various functions), and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Conventionally, people may need to spend a long time to pick up the commodities they want to buy for example in a supermarket. On the other hand, picking up the commodities by the customers themselves may further lead to potential safety issues. For example, due to the spread of COVID-19, the crowd congestion of customers may increase the risk or virus transmission. Therefore, it is desired to provide the customers a more efficient and safe way to pick up the commodities they want to buy.

According to embodiments of the present disclosure, there is providing a solution for shopping guiding with robot assistance. In the solution, a shopping list of a customer is obtained, wherein the shopping list comprises a plurality of commodities to be picked up. Further, a first set of commodities are determined from the plurality of commodities based on predicted picking up costs for the plurality of commodities, and at least one robot are assigned for automatically picking up the first set of commodities. As such, at least one robot may be assigned for picking up commodities with a relative high picking up cost, thereby increasing the efficiency for shopping and decreasing the safety risks.

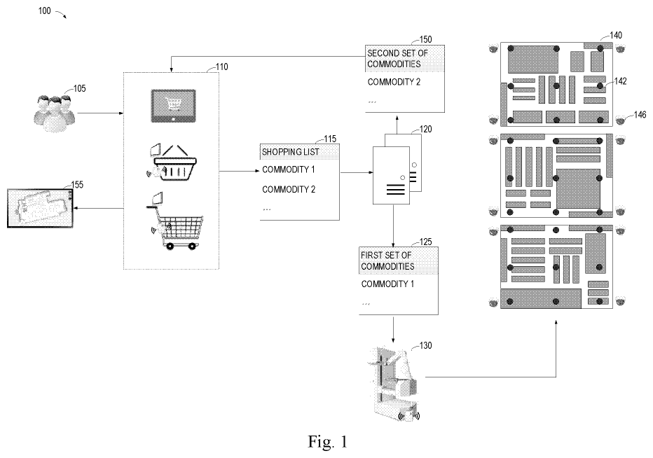

Principle and embodiments of the present disclosure will be described in detail below with reference to the accompanying drawings. Reference is first made to FIG. 1, which illustrates an example environment 100 in which example embodiments of the present disclosure may be implemented.

As shown in FIG. 1, the example environment 100 comprises a shopping guiding device 120. The shopping guiding device 120 may receive a shopping list 115 of a customer 105. In some example embodiments, the shopping list 115 may be received from a terminal device 110, which is communicatively coupled to the shopping guiding device 120.

In some example embodiments, the terminal device 110 may comprise a personal terminal device of the customer 105, e.g., a smart phone or a tablet. The shopping list 115 may be generated by the terminal device 110 through a shopping application installed thereon. For example, the customer 105 may first login to the shopping application and select the commodities they want to buy before they move to the shopping place for picking up the commodities.

In some other example embodiments, the terminal device 110 may comprise a common terminal device of the shopping place (e.g., a supermarket). For example, a customer may go to a shopping place, and use a common terminal device provided by the shopping place to select the commodities they want to buy. Examples of such common terminal device may comprise a self-service machine which allows the user to select the commodities for example through a touch screen of the self-service machine.

In some further example embodiments, the terminal device 110 may comprise a terminal device deployed on a shopping basket or a shopping cart. For example, when a customer 105 goes to a supermarket, he or she may select a shopping cart or a shopping basket before he or she starts picking up the commodities. Such a shopping cart or shopping basket may be deployed with a terminal device, e.g., a tablet. On the tablet, the customer may select the commodities they want to buy for generating the shopping list 115.

The shopping list 115 may then be transmitted to the shopping guiding device 120 through wire or wireless communication. As shown in FIG. 1, the shopping list 115 may comprise a plurality of commodities.

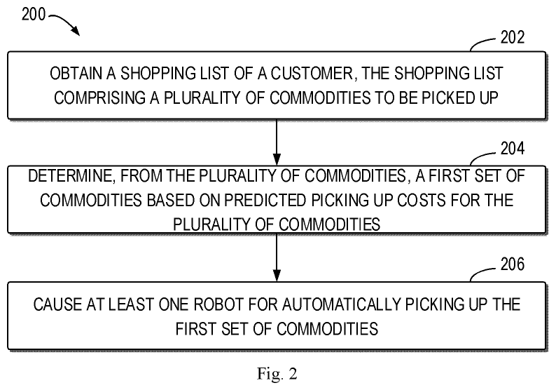

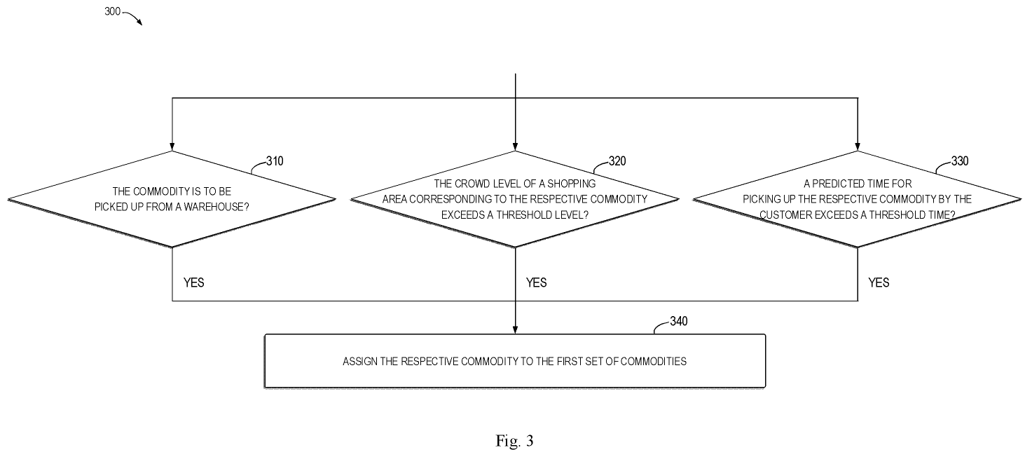

To improve the efficiency of picking up the commodities, the shopping guiding device 120 may determine the predicted picking up costs for the plurality of commodities included in the shopping list 115. Based on the determined predicted picking up costs, a first set of commodities 125 are determined from the plurality of commodities by the shopping guiding device 120. The detailed process for determining the first set of commodities 125 will be discussed below with reference to FIGS. 2 and 3.

Further, at least one robot 130 is then caused to pick up the determined first set of commodities 125 from the shopping place 140. In particular, the at least one robot 130 may pick up the first set of commodities 125 based on position information of the first set of commodities 125.

In some example embodiments, position information of the commodities provided by a shopping place 140 may be maintained. Position information of a commodity may for example comprise a shelf holding the commodity and a shopping area of the shelf. The at least one robot 130 may determine a position of the commodity based on the position information and move to the position to pick up the commodity.

In some example commodities, a second set of commodities 150 may also be determined from the plurality of commodities included in the shopping list 115. For example, the commodities which are not assigned to the first set of commodities 150 may be included in the second set of commodities 150.

Further, the second set of commodities 150 may be assigned to the customer 105 for picking up by himself/herself. In this way, the solution according to the example embodiments may not only improve the efficiency of picking up commodities without diminishing the shopping experiences of the customer.

In some example embodiments, position information of the second set of commodities 150 may be determined and then a route for navigating the customer to pick up the second set of commodities may be generated based on the positions of the second set of commodities 150.

For example, the route may be provided to the customer 105 via a user interface 155 of the terminal device 110, thereby guiding the customer to pick up the second set of commodities according to the route.

In some example embodiments, as show in FIG. 1, a plurality of cameras 146 may be deployed in different shopping areas in shopping place 140 to monitor the customer flow in real-time. As will be discussed in detail below, the monitored customer flow may be used to determine the predicted picking up cost.

In some example embodiments, a plurality of in-door positioning devices 142 may be deployed in the shopping place 140. For example, a plurality of anchors may be placed on the dropped ceiling of the store to form a homogeneous grid to cover the entire supermarket. Such anchors may be used to gather signals from the UWB (Ultra Wide Band Radio) tags for example deployed on the shopping basket or shopping carts to monitor the in-door position of the corresponding customer. Further, such anchors may also be utilized to track the position of the at least one robot 130 based on the signal received from the UWB tags on the at least one robot 130.

Reference is now made to FIG. 2, which shows a process 200 for shopping guiding according to an example embodiment of the present disclosure. For the purpose of discussion, the process 200 will be described with reference to FIG. 1. The process 200 may involve the shopping guiding device 120 as illustrated in FIG. 1.

As shown in FIG. 2, at 202, the shopping guiding device 120 obtains a shopping list 115 of a customer 105, wherein the shopping list 115 comprises a plurality of commodities to be picked up.

As discussed above with reference to FIG. 1, the customer may use a terminal device 110 for generating the shopping list 115. The terminal device 110 may comprise a personal terminal device of the customer 105, a terminal device deployed on a shopping cart or a shopping basket, or a common terminal device for the shopping place 140.

In some example embodiments, upon generating the shopping list 115, the terminal device 110 may also obtain an identification of the customer 105. For example, the terminal device 110 may require the customer 105 to login his or her account upon generating the shopping list 115. It should be understood that the identification of the customer 105 is used to uniquely identify the customer 105, and any proper types of identifications might be used, for example, a telephone number, an email address or the like. As will be discussed below, the identification of the customer may be utilized to determine the predicted picking up cost of the plurality of commodities in the shopping list 115.

At 204, the shopping guiding device 120 determines, from the plurality of commodities, a first set of commodities 125 based on predicted picking up costs for the plurality of commodities.

In some example embodiments, a predicted picking up cost of a commodity may be determined based on a position of the commodity in the shopping place 140. In particular, the shopping guiding device 120 may obtain commodity information for the plurality of commodities, wherein the commodity information may at least indicates whether a respective commodity is to be picked up from a warehouse.

The shopping guiding device 120 may further determine the predicted picking up cost based on the commodity information. The predicted picking up cost may indicate whether a respective commodity is out of stock on the shelf. It shall be understood that, if a respective commodity is out of stock on a shelf and needs to be picked up from a warehouse, it may take the customer 105 longer time to pick up the respective commodity.

FIG. 3 illustrates a flowchart of a process 300 for determining the first set of commodities according to some example embodiments of the present disclosure. At 310, the shopping guiding device 120 may determine whether the commodity information indicate that a respective commodity is to be picked up from a warehouse.

If it is determined at 310 that a respective commodity is to be picked up from a warehouse, the process 300 proceeds to 340, where the shopping guiding device 120 may assign the respective commodity to the first set of commodities 125.

If it is determined at 310 that a respective commodity is not to be picked up from a warehouse, the shopping guiding device 120 may simply assign the respective commodity to the second set of commodities 150. Alternatively, some further criteria may be utilized to determine whether a respective commodity shall be assigned to the first set of commodities.

In this way, the example embodiments of the present disclosure may prevent a customer from picking up a commodity from the warehouse by himself/herself, thereby improving the shopping experience of the customer.

In some example embodiments, a predicted picking up cost of a commodity may be determined based on a crowd level of a shopping area corresponding to a respective commodity. The crowd level may for example be determined based on how many customers are now in the shopping area corresponding to a respective commodity. Further, a predicted picking up cost of a commodity may be determined based on the determined crowd level.

In some example embodiments, the shopping guiding device 120 may first determine the number of customers in the shopping area within a predetermined time period, and then determining the crowd level of the shopping area based on the number of customers.

In some example embodiments, the crowd level of the shopping area may be determined based on at least one image of the shopping area. In particular, the shopping guiding device 120 may first determine the shopping area corresponding to a respective commodity based on its position information. Further, the shopping guiding device 120 may obtain at least one image of the shopping area, for example, utilizing at least one corresponding cameras 146 as deployed in the shopping place 140.

The shopping guiding device 120 may further determine the number of customers in the shopping area based on the obtained at least one image. It shall be understood that any proper image recognition methods might be utilized to determine the number of customers from the image, and the disclosure is not aimed to be limited in this regard.

In some other example embodiments, the crowd level of the shopping area may be determined based on real time positions of customers in the shopping place 140. In particular, the shopping guiding device 120 may obtain positions of a plurality of customers. For example, the shopping guiding device 120 may utilize the plurality anchors to receive the signals from the UWB tags deployed on a shopping cart or a shopping basket to determine the in-door positions of the plurality of customers. It shall be understood that any other proper in-door positioning methods might also be utilized to determine the positions of the customers, and the disclosure is not aimed to be limited in this regard.

Further, the shopping guiding device 120 may determine the number of customers in the shopping area by comparing the positions of the plurality of customers with the shopping area.

In some further example embodiments, the crowd level of the shopping area may be determined based historical crowd levels. As an example, the crow level may be determined based on an average of historical crowd levels for the particular shopping area. For example, a crowd level of a particular shopping area may be determined based on an average of the crowd levels in the past one week.

In some other example embodiments, the crow level may for example be determined using a machine learning model. As an example, a machine learning model may be trained using the historical crowd levels of a shopping area corresponding to a commodity. Such historical crowd levels may be used as the ground-truth data during the training, and the corresponding features input into the model may comprise various types of features.

In some example embodiments, such input features may comprise commodity features, such as, a category of the commodity, a price of the commodity, a position of the commodity, a discount of the commodity, and the like. In some further example embodiments, such features may comprise temporal features, such as, a month of a year, a day of a month, a day of a week, time of a day, a holiday or the like. In some further example embodiments, such features may also comprise environmental features, such as, current weather conditions, current traffic conditions around the shopping place or the like.

In some further example embodiments, the input features may comprise the combination of two or more of the commodity features, the temporal features or the environmental features. Further, it shall also be understood that the detailed features as listed above are exemplary, and any other proper types of features may also be included for training the machine learning model.

After the machine learning model has been trained using the historical crowd levels and corresponding input features, the trained machine learning model will be capable of predicting a current crowd level of a shopping place based on the practical features. For example, the machine learning model may determine based on the input features that a crowd level of a shopping area corresponding to a children toy is relative high on the afternoon of weekends.

It shall be understood that any proper machine learning models may be utilized for predicting the crowd level, and the disclosure is not aimed to be limited in this regard.

As show in FIG. 3, at 320, the shopping guiding device 120 may determine whether the crowd level of a shopping area corresponding to the respective commodity exceeds a threshold level.

If it is determined at 320 that the crowd level of a shopping area corresponding to the respective commodity exceeds a threshold level, the process 300 proceeds to 340, where the shopping guiding device 120 may assign the respective commodity to the first set of commodities 125.

If it is determined at 320 that the crowd level of a shopping area corresponding to the respective commodity is below or equal to a threshold level, the shopping guiding device 120 may simply assign the respective commodity to the second set of commodities 150. Alternatively, some further criteria may be utilized to determine whether a respective commodity shall be assigned to the first set of commodities.

In this way, the example embodiments of the present disclosure may prevent a customer from picking up a commodity in a shopping area with high crowd level, thereby improving the shopping experience of the customer and decreasing the safety risk, e.g., the risk of virus transmission.

In some example embodiments, a predicted picking up cost of a commodity may be determined based on a predicted time for picking up the commodity by the customer 105.

In some example embodiment, the shopping guiding device 120 may determine the predicted time for picking up the respective commodity utilizing a prediction model, wherein the prediction model is trained with historical shopping information of the customer and the historical shopping information may at least comprise a historical time for picking up a commodity by the customer.

The historical time for picking up a commodity by the customer may for example be determined based on a length of a time period when the customer is within a predetermined distance to the commodity. Alternatively, the historical time for picking up a commodity by the customer may for example based on the video recording the process of picking up the commodity by the customer.

For example, the shopping guiding device 120 may obtain the historical shopping information of the customer 105, and then train a machine learning model using the historical shopping information for predicting how much time the customer 105 will spend on picking up a particular commodity.

For example, the training data may comprise a historical shopping list (or the historical commodities included in the historical shopping list) and the historical shopping time spent on picking up each of the historical commodities by the customer. For example, the historical shopping list may comprise {commodity A, commodity B, commodity C}, and the historical time may comprise {5 minutes, 10 minutes, 7 minutes}.

By training a machine learning model using such historical shopping information, the trained prediction shall be capable of receive a shopping list or a plurality of commodities, and output how much time the customer 105 will spend on picking up each of the plurality of commodities in the shopping list 115.

It shall be understood that any proper machine leaning models may be used as the prediction model herein, and the disclosure is not aimed to be limited in this regard.

For example, the shopping guiding device 120 may determine, based on the identification of the customer 105 received from the terminal device 110, whether profile information of the customer 105 has been obtained.

As shown in FIG. 3, at 330, the shopping guiding device 120 may determine whether the predicted time for picking up the respective commodity by the customer exceeds a threshold time.

In some example embodiments, the threshold time may comprise a predefined value. In some example embodiments, a threshold time for the respective commodity may be set as the average picking up time for all the customers. If the predicted time for picking up a particular commodity is greater than an average time, the process may proceed to 340, where the shopping guiding device 120 may assign the assign the respective commodity to the first set of commodities 125.

In some other example embodiments, a predicted picking up cost of a commodity may be determined based on an average time for picking up the respective commodity. For example, the shopping guiding device 120 may collect the historical time spent for picking up the commodity by all customers, and then determine the average time based on the historical time.

In some example embodiments, the predicted picking up cost of a commodity may be determined based on an average time only when no historical shopping information is maintained for the customer 105.

For example, if the customer 105 fails to provide his/her identification or the customer 105 is new to the shopping place 140, the shopping guiding device 120 may be unable to retrieve the historical shopping information of the customer 105. In that case, there might be not enough data for training a prediction model as discussed above, and an average time may be used as a predicted time for picking up a respective commodity.

If the average time is to be used as the predicted time for picking up a respective commodity by the customer 105, the threshold discussed at 330 may be set as a predefined value.

Alternatively, the threshold discussed at 330 may also be set as an average picking up time of all the commodities by all the customers. For example, if an average picking up time of a particular commodity is greater than an overall average picking up time, the process 300 may proceed to 340, where the shopping guiding device 120 may assign the assign the respective commodity to the first set of commodities 125.

If it is determined at 330 that the predicted time for picking up the respective commodity is below or equal to the threshold time, the shopping guiding device 120 may simply assign the respective commodity to the second set of commodities 150. Alternatively, some further criteria may be utilized to determine whether a respective commodity shall be assigned to the first set of commodities.

In this way, the example embodiments of the present disclosure may prevent a customer from spending too much time on a single commodity, thereby improving shopping efficiency.

It shall be noted that, though steps 310, 320 and 330 are shown as parallel processes in FIG. 3, such steps 310, 320 and 330 may also be performed in sequence. For example, the shopping guiding device 120 may first determine at 310 whether a respective commodity is to be picked up from a warehouse. If not, the shopping guiding device 120 may further determine at 320 whether a crow level of a shopping area corresponding to the respective commodity exceeds the threshold level. If not, the shopping guiding device 120 may further determine at 330 whether a predicted time for picking up the respective commodity by the customer exceeds a threshold time.

In this case, only when none of the above three conditions are satisfied, the shopping guiding device 120 may assign the respective commodity to the second set of commodities 150.

Referring back to FIG. 2, at 206, the shopping guiding device 120 causes at least one robot for automatically picking up the first set of commodities.

In some example embodiments, a plurality of robots which have the abilities to pick up the commodities on the shelf may be deployed in the shopping place 140. For example, a robot may utilize a mechanical arm to pick up a commodity on a shelf or in the warehouse. Further, the robot may also have one or more baskets which are capable of holding the commodities picked up from the shelf or warehouse.

In some example embodiments, the shopping guiding device 120 may send the first set of commodities 125 to the at least one robot 130. The at least one robot 130 may further obtain a route for picking up the first set of commodities. The route may for example be generated at least based on the positions of the first set of commodities by any proper devices. For example, the at least one robot 130 itself may determine the route using any proper route planning method. Alternatively, the at least one robot 130 may receive the route from a remote device, e.g., the shopping guiding device 120. It shall be understood that any proper route planning methods may be utilized herein, and the disclosure is not aimed to be limited in this regard.

In some example embodiments, the at least one robot 130 may be derived to pick up the first set of commodities according to the obtained route. In this way, the example embodiments according to the present disclosure may improve the efficiency for shopping and also decrease the safety risks.

In some example embodiments, the shopping guiding device 120 may also determine a second set of commodities 150 from the plurality of commodities, wherein the second set of commodities comprising at least one commodity to be manually picked up by the customer. For example, commodities which are not assigned to the first set of commodities 125 may be included in the second set of commodities 150.

Further, the shopping guiding device 120 may provide the customer 105 with picking up information of the second set of commodities 105 comprising at least one of the followings: a route for picking the second set of commodities, a predicted time for picking up the second set of commodities, or positions of the second set of commodities.

For example, as discussed in FIG. 1, the shopping guiding device 120 may send the picking up information to the terminal device for present such picking up information for example through a user interface 155.

As such, the example embodiments according to the present disclosure may enable the customer to continue participating in shopping with for example higher shopping efficiency and lower safety risk.

In some example embodiments, the shopping guiding device 120 may determining a first predicted time of picking up the first set of commodities 125 by one robot and determine a second predicted time of picking up the second set of commodities by the customer.

For example, the shopping guiding device 120 may determine a first predicted time of picking up as a time a single robot will spend to pick up the first set of commodities 125, and determined the second predicted time based on the planed route for the second set of commodities 150. It shall be understood that any proper navigation method may be applied to determine the first predicted time and the second predicted time, and the disclosure is not aimed to be limited in this regard.

Further, the shopping guiding device may further determine the number of the at least one robots to be used for picking up the first set of commodities based on a comparison between the first predicted time and the second predicted time, such that a predicted time for the at least one robot 130 to pick up the first set of commodities 125 is less or equal to the second predicted time.

For example, if the first predicted time is less than the second predicted time, the at least one robot 130 may finish picking up the first set of commodities 125 before the customer 105 finishes picking up the second set of commodities 150. In this way, a good shopping experience may be gained by the customer 105.

On the other hand, if the first predicted time is greater the second predicted time, the customer 105 may need to wait for the at least one robot 130 after he or she finishes picking up the second set of commodities 150. This may affect the shopping experience of the customer.

In some example embodiments, if the first predicted time is greater the second predicted time, one or more additional robot may be assigned for picking up the first set of commodities, such that a predicted time for the at least one robot 130 to pick up the first set of commodities 125 is less or equal to the second predicted time. In this way, it can be ensured that the robot could always finish picking up the first set of commodities earlier than the customer finishes picking up the second set of commodities, thereby improving the shopping experience of the customer.

In some example embodiments, the shopping guiding device 120 may further track a position of the customer during picking up the second set of commodities 150. The position of the customer 105 may for example be determined based on a position of a personal terminal device of the customer 105. Alternatively, the position of the customer 105 may also be determined based on a wireless positioning tag (e.g., a UWB tag) attached to a shopping cart or a shopping basket of the customer 105.

Further, in accordance with a determination that the at least one robot finishes picking up the first set of commodities, the at least one robot 130 may be caused to move to a position of the customer 105.

As discussed, a position of the customer 105 may be tracked during the shopping, and the at least one robot 130 may obtain a real time position of the customer 105 after finishing picking up the first set of commodities 125, and move to that position for providing the customer 105 the picked up commodities.

In some example embodiments, the customer 105 may be further enabled to check out the commodities directly through the at least one robot 130. For example, the at least one robot 130 may receiving payment information from the customer 105. For example, the at least one robot 130 may comprise a POS machine to receive credit card information from the customer 105, a camera to recognizing the customer's face for payment based on face recognition, a barcode scanner to scan the payment barcode generated for example by a personal terminal device of the customer.

In some example embodiments, the at least one robot 130 may for example obtain the shopping list 115 of the customer 105 and checking out the commodities in the shopping list 115 without scanning the commodities one by one. In this way, the efficiency of checking out commodities may be improved. In some example embodiments, the at least one robot 130 may comprise a scanner configured to scan the barcodes on the commodities for checking out the commodities.

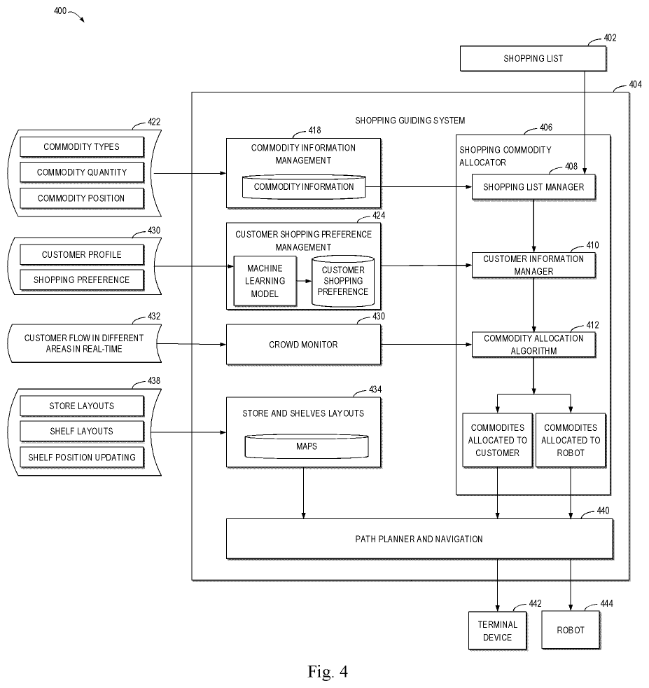

FIG. 4 illustrates a block diagram of an example shopping system 400 according to some example embodiments of the present disclosure. As shown in FIG. 4, the shopping system 400 comprises a shopping guiding system 404, and there are six modules in the shopping guiding system 404, named as commodity information management 418, customer shopping preference management 424, shopping commodity allocator 406, store and shelf layouts 434, crowd monitor 430, and path planer and navigation 440. Each module may be based on knowledge base system and machine learning.

Commodity information management (CIM) module 418 may receive different types of commodity information 422, such as commodity types, commodity quantity, and commodity position from staffs in supermarket. Such commodity information 422 may be stored in CIM module 418. For example, when a barcode scanner scans the barcode on the commodities by a shelf management staff or a cashier in supermarket, the quantity of the commodities will increases or decreases correspondingly. If a commodity in a customer's list is out of stock on the shelf, the CIM module 418 may notify the robot in warehouse to pick up the commodity in warehouse, and provide it to the customer at the check-out area.

Customer shopping preference management (CSPM) module 424 may learn from historical shopping records of a customer who has register his/her profiles in the system, thus to better predict the shopping time spent on every commodity by the customer. By training the embedded machine learning system with the historical shopping list and corresponding shopping time spent on every commodity in the shopping list, the trained machine learning system may be used to draw customer's shopping preference. The shopping time spent on every commodity by the customer may then be predicted.

Crowd monitor (CM) module 430 may monitor the customer flow captured by cameras in different shopping areas in different time.

The store maps such as the store layouts and shelf layouts may be stored in the store and shelf layouts (SSL) module 434. This SSL module provides the navigation maps in supermarket. If the staffs in supermarkets move the shelves in supermarkets to new positions, the position change of the shelves can be monitored by the cameras, and the maps in the SSL module 434 will be updated.

Shopping commodity allocator (SCA) module 406 may allocates the commodities between customer and robot according to the process as discussed with reference to FIGS. 2 and 3. When receiving a shopping list 402 of a customer, the shopping list manager 408 checks the commodity information through checking necessary data in CIM module 418 in knowledge system. If a commodity in the shopping list 404 is out of stock on the shelf, the SCA module 406 may inform robot in warehouse to pick up the commodity, and provide it to the customer.

If the commodity is in stock on the shelf, the SCA module 406 may communicate with CIM module 424 and SSL module 434 to get the position of the commodity. Then through communication with CM module 430, the customer flow of the shopping area the commodity belongs to can be checked. If the customer flow in the shopping areas is big, the commodity may be added into the picking up queue of a robot.

If the customer flow in the shopping area is small, the customer information manager 410 communicates with CSPM 424 to check whether the customer's profile is in the system. If the customer's profile is in the system, the customer information manager 410 may check the shopping preference of the customer in CSPM 424 to predict the picking up time (Tₛ) spent on the commodity. If the shopping time Tₛ<Tₐ, where Tₐ is the average picking up time of the commodity by all the customers, the commodity is added into the picking up queue of the customer. Otherwise, if Tₛ≥Tₐ, the commodity is added into the picking up queue of the robot.

If the customer's profile is not in the system, Tₛ is set as Tₐ. If Tₛ<Tₐₐ, the commodity is added into the picking up queue of the customer, where Tₐₐ is the average picking up time of all the commodities by all the customers. If Tₛ>Tₐₐ, the commodity is added into the picking up queue of robot.

After all the commodities in the shopping list are allocated, the SCA 406 calculates the overall picking time of customer T_{c} and the overall picking time of the robot Tᵣ. If Tᵣ<T_{c}, the SCA 406 allocates the picking up queue of robot to a single robot. If Tᵣ≥T_{c}, the SCA allocates the picking up queue of robot to multiple robots, which can guarantee the robots finish picking up items before the customer.

Path planer and navigation (PPN) module 440 may provide navigation for the customer and the robot, based on the commodities allocation by SCA module 406. PPN module 440 may navigate the robot 440 to pick up the commodities, and provide navigation information to a terminal device 442 to direct the customer to pick up the commodities allocated to the customer. When the robot finish picking up all the commodities and if the customer finishes his/her picking up, PPN module 440 will navigate the robot to the position of the customer. The robot may then provide the commodities to the customer and enable the customer checking out through the robot. In this way, the paying will be convenient and the customer doesn't need to scan every items. Instead, the customer just needs confirm the shopping list show on the LCD touch-screen deployed on the robot, and finish paying. This can significantly shorten the paying time.

When the robot finishes picking up all the items, if the customer has not finished picking up the commodities yet, the robot can help another customer to pick up commodities until the previous customer finishes picking up the commodities.

In some example embodiments, an apparatus capable of performing any of the method 200 (for example, the shopping guiding device 120) may comprise means for performing the respective steps of the method 200. The means may be implemented in any suitable form. For example, the means may be implemented in a circuitry or software module.

In some example embodiments, the apparatus comprises means for obtaining a shopping list of a customer, the shopping list comprising a plurality of commodities to be picked up; determining, from the plurality of commodities, a first set of commodities based on predicted picking up costs for the plurality of commodities; and causing at least one robot for automatically picking up the first set of commodities

In some example embodiments, the apparatus further comprises means for performing other steps in some example embodiments of the method 200. In some example embodiments, the means comprises at least one processor; and at least one memory including computer program code, the at least one memory and computer program code configured to, with the at least one processor, cause the performance of the apparatus.

In some example embodiments, the apparatus further comprises means for receiving the shopping list from at least one of the followings: a personal terminal device of the customer, a terminal device deployed on a shopping cart, a terminal device deployed on a shopping basket, or a common terminal device for a shopping place.

In some example embodiments, the apparatus further comprises means for obtaining commodity information for the plurality of commodities, the commodity information at least indicating whether a respective commodity is to be picked up from a warehouse; and determining the predicted picking up costs based on the commodity information.

In some example embodiments, the apparatus further comprises means for in accordance with a determination that the commodity information indicates that the respective commodity is to be picked up from a warehouse, assigning the respective commodity to the first set of commodities.

In some example embodiments, the apparatus further comprises means for determining a crowd level of a shopping area corresponding to a respective commodity; and determining the predicted picking up costs based on the crowd level.

In some example embodiments, the apparatus further comprises means for in accordance with a determination that the crowd level of a shopping area corresponding to the respective commodity exceeds a threshold level, assigning the respective commodity to the first set of commodities.

In some example embodiments, the apparatus further comprises means for determining the shopping area based on a position of the respective commodity; determining the number of customers in the shopping area within a predetermined time period; and determining the crowd level of the shopping area based on the number of customers.

In some example embodiments, the apparatus further comprises means for obtaining at least one image of the shopping area; and determining the number of customers in the shopping area based on the obtained at least one image.

In some example embodiments, the apparatus further comprises means for obtaining positions of a plurality of customers; and determining the number of customers in the shopping area by comparing the positions with the shopping area.

In some example embodiments, the apparatus further comprises means for Determining a predicted time for picking up a respective commodity by the customer; and determining the predicted picking up cost based on the predicted time.

In some example embodiments, the apparatus further comprises means for determining the predicted time for picking up the respective commodity utilizing a prediction model, the prediction model trained with historical shopping information of the customer, the historical shopping information at least comprising a historical time for picking up a commodity by the customer.

In some example embodiments, the apparatus further comprises means for obtaining an average time for picking up the respective commodity; and determined the predicted time based on the average time.

In some example embodiments, the apparatus further comprises means for in accordance with a determination that the predicted time for picking up the respective commodity by the customer exceeds a threshold time, assigning the respective commodity to the first set of commodities.

In some example embodiments, the apparatus further comprises means for determining a second set of commodities from the plurality of commodities, the second set of commodities comprising at least one commodity to be manually picked up by the customer; and providing the customer with picking up information of the second set of commodities comprising at least one of the followings: a route for picking the second set of commodities, a predicted time for picking up the second set of commodities, or positions of the second set of commodities.

In some example embodiments, the apparatus further comprises means for tracking a position of the customer during picking up the second set of commodities based on at least one of: a position of a personal terminal device of the customer, or a wireless positioning tag attached to a shopping cart or a shopping basket of the customer.

In some example embodiments, the apparatus further comprises means for determining a first predicted time of picking up the first set of commodities by one robot; determining a second predicted time of picking up the second set of commodities by the customer; and determining the number of the at least one robots to be used for picking up the first set of commodities based on a comparison between the first predicted time and the second predicted time, such that a predicted time for the at least one robot to pick up the first set of commodities is less or equal to the second predicted time.

In some example embodiments, in accordance with a determination that the at least one robot finishes picking up the first set of commodities, the at least one robot is caused to move to a position of the customer.

In some example embodiments, the apparatus further comprises means for receiving, through the at least one robot, payment information from the customer for checking out the plurality of commodities.

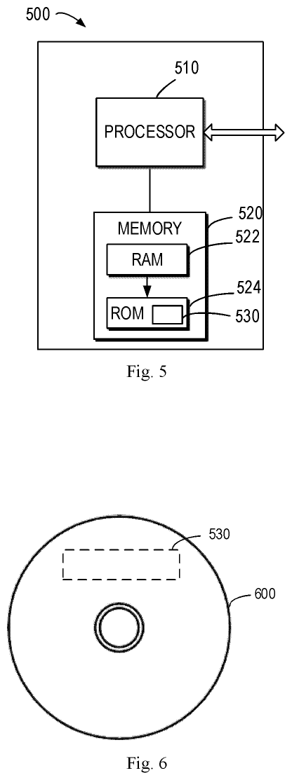

FIG. 5 is a simplified block diagram of a device 500 that is suitable for implementing example embodiments of the present disclosure. The device 500 may be provided to implement the communication device, for example the shopping guiding device 120 as shown in FIG. 1. As shown, the device 500 includes one or more processors 510, and one or more memories 520 coupled to the processor 510.

In some example embodiments, the device 500 may comprise one or more communication modules (not shown in FIG. 5) coupled to the processor 510. The communication module is for bidirectional communications. The communication module has at least one antenna to facilitate communication. The communication interface may represent any interface that is necessary for communication with other network elements.

The processor 510 may be of any type suitable to the local technical network and may include one or more of the following: general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a Read Only Memory (ROM) 524, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 522 and other volatile memories that will not last in the power-down duration.

A computer program 530 includes computer executable instructions that are executed by the associated processor 510. The program 530 may be stored in the memory, e.g., ROM 524. The processor 510 may perform any suitable actions and processing by loading the program 530 into the RAM 522.

The example embodiments of the present disclosure may be implemented by means of the program 530 so that the device 500 may perform any process of the disclosure as discussed with reference to FIGS. 2 to 3. The example embodiments of the present disclosure may also be implemented by hardware or by a combination of software and hardware.

In some example embodiments, the program 530 may be tangibly contained in a computer readable medium which may be included in the device 500 (such as in the memory 520) or other storage devices that are accessible by the device 500. The device 500 may load the program 530 from the computer readable medium to the RAM 522 for execution. The computer readable medium may include any types of tangible non-volatile storage, such as ROM, EPROM, a flash memory, a hard disk, CD, DVD, and the like. FIG. 6 shows an example of the computer readable medium 600 in form of CD or DVD. The computer readable medium 600 has the program 530 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 200 as described above with reference to FIGS. 2-3. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-40. (canceled)

41. A device, comprising:
at least one processor; and
at least one memory storing instructions that, when executed by the at least processor, cause the device at least to:
obtain a shopping list of a customer, the shopping list comprising a plurality of commodities to be picked up;
determine, from the plurality of commodities, a first set of commodities based on predicted picking up costs for the plurality of commodities; and
cause at least one robot for automatically picking up the first set of commodities.

42. The device of claim 41, wherein the obtaining of the shopping list of the customer further comprises:
receive the shopping list from at least one of the followings: a personal terminal device of the customer, a terminal device deployed on a shopping cart, a terminal device deployed on a shopping basket, or a common terminal device for a shopping place.

43. The device of claim 41, wherein the instructions, when executed with the at least one processor, further cause the device to:
obtain commodity information for the plurality of commodities, the commodity information at least indicating whether a respective commodity is to be picked up from a warehouse; and
determine the predicted picking up costs based on the commodity information.

44. The device of claim 43, wherein the determining of the first set of commodities further comprises:
in accordance with a determination that the commodity information indicates that the respective commodity is to be picked up from a warehouse, assign the respective commodity to the first set of commodities.

45. The device of claim 41, wherein the instructions, when executed with the at least one processor, further cause the device to:
determine a crowd level of a shopping area corresponding to a respective commodity; and
determine the predicted picking up costs based on the crowd level.

46. The device of claim 45, wherein the determining of the first set of commodities further comprises:
in accordance with a determination that the crowd level of the shopping area corresponding to the respective commodity exceeds a threshold level, assign the respective commodity to the first set of commodities.

47. The device of claim 45, wherein the determining of the crowd level of the shopping area corresponding to the respective commodity further comprises:
determine the shopping area based on a position of the respective commodity;
determine the number of customers in the shopping area within a predetermined time period; and
determine the crowd level of the shopping area based on the number of customers.

48. The device of claim 47, wherein the determining of the number of customers in the shopping area within a predetermined time period further comprises:
obtain at least one image of the shopping area; and
determine the number of customers in the shopping area based on the obtained at least one image.

49. The device of claim 47, wherein the determining of the number of customers in the shopping area within a predetermined time period further comprises:
obtain positions of a plurality of customers; and
determine the number of customers in the shopping area by comparing the positions with the shopping area.

50. The device of claim 45, wherein the determining of the crowd level of the shopping area corresponding to the respective commodity further comprises:
determine the shopping area based on a position of the respective commodity; and
determine the crowd level of the shopping area using a machine learning model, the machine learning model being trained using historical crowd levels of shopping areas and corresponding features, the corresponding features comprising at least one of: commodity features, temporal features or environmental features.

51. The device of claim 41, wherein the instructions, when executed with the at least one processor, further cause the device to:
determine a predicted time for picking up a respective commodity by the customer; and
determine the predicted picking up cost based on the predicted time.

52. The device of claim 51, wherein the determining of the predicted time for picking up the respective commodity by the customer further comprises:
determine the predicted time for picking up the respective commodity utilizing a prediction model, the prediction model trained with historical shopping information of the customer, the historical shopping information at least comprising a historical time for picking up a commodity by the customer.

53. The device of claim 51, wherein the determining of the predicted time for picking up the respective commodity is performed by the customer by:
obtaining an average time for picking up the respective commodity; and
determining the predicted time based on the average time.

54. The device of claim 41, wherein the determining of the first set of commodities further comprises:
in accordance with a determination that the predicted time for picking up the respective commodity by the customer exceeds a threshold time, assigning the respective commodity to the first set of commodities.

55. The device of claim 41, wherein the instructions, when executed with the at least one processor, further cause the device to:
determine a second set of commodities from the plurality of commodities, the second set of commodities comprising at least one commodity to be manually picked up by the customer; and
provide the customer with picking up information of the second set of commodities comprising at least one of the followings: a route for picking the second set of commodities, a predicted time for picking up the second set of commodities, or positions of the second set of commodities.

56. The device of claim 55, wherein the instructions, when executed with the at least one processor, further cause the device to:
track a position of the customer during picking up the second set of commodities based on at least one of:
a position of a personal terminal device of the customer, or
a wireless positioning tag attached to a shopping cart or a shopping basket of the customer.

57. The device of claim 55, wherein the instructions, when executed with the at least one processor, further cause the device to:
determine a first predicted time of picking up the first set of commodities by one robot;
determine a second predicted time of picking up the second set of commodities by the customer; and
determine the number of the at least one robots to be used for picking up the first set of commodities based on a comparison between the first predicted time and the second predicted time, such that a predicted time for the at least one robot to pick up the first set of commodities is less or equal to the second predicted time.

58. The device of claim 57, wherein,
in accordance with a determination that the at least one robot finishes picking up the first set of commodities, the at least one robot is caused to move to a position of the customer.

59. The device of claim 41, wherein the instructions, when executed with the at least one processor, further cause the device to:
receive, through the at least one robot, payment information from the customer for checking out the plurality of commodities.

60. A method comprising:
obtaining a shopping list of a customer, the shopping list comprising a plurality of commodities to be picked up;
determining, from the plurality of commodities, a first set of commodities based on predicted picking up costs for the plurality of commodities; and
causing at least one robot for automatically picking up the first set of commodities.

61. A non-transitory computer readable medium comprising program instructions, when executed by an apparatus, cause the apparatus to perform at least the following:
obtaining a shopping list of a customer, the shopping list comprising a plurality of commodities to be picked up;
determining, from the plurality of commodities, a first set of commodities based on predicted picking up costs for the plurality of commodities; and
causing at least one robot for automatically picking up the first set of commodities.
